(19) United States
(12) Patent Application Publication
(10) Pub. No.: US 2024/0056713 A1
(43) Pub. Date: Feb. 15, 2024

(54) SPEAKER APPARATUS

(71) Applicant: AFCO, Inc., Memphis, TN (US)

(72) Inventors: Brad Diedrich, Depere, WI (US); Joseph LoMonaco, San Diego, CA (US); Blake Franchini, Germantown, TN (US)

(73) Assignee: AFCO, Inc., Memphis, TN (US)

(21) Appl. No.: 17/886,871

(22) Filed: Aug. 12, 2022

(51) Int. Cl. H04R 1/02

(52) U.S. Cl. CPC H04R 1/023

(57) ABSTRACT

A speaker apparatus comprising a woofer and an array of tweeters positioned in front of the woofer. In some embodiments, the array comprises at least three tweeters and the speaker apparatus is suitable for use in aquatic environments.

### FIELD OF INVENTION

The embodiments described herein relate to audio speakers and speaker apparatuses for use in a variety of situations, including but not limited to, aquatic environments.

### BACKGROUND

An audio speaker, or loudspeaker, is an apparatus that converts electrical audio signals into sound which can be heard at distance. With the proliferation of music, there is a general need for loudspeakers with improved efficiency, sound quality, and a clear output at all frequencies. In order to maximize accuracy and sound quality, many loudspeakers will employ more than one driver and these are often referred to as “multi-driver speakers” or “full-range speakers.” Subwoofers (also referred to herein as “woofer(s)”) are frequently used to produce the low-pitched audio frequencies, such as bass and sub-bass often in the 20 Hz-2,000 Hz range. Mid-range drivers are often used for the middle frequencies typically between 50 Hz-10 kHz, and a compression driver or tweeter usually produce the higher-pitched audio frequencies often between 1 kHz-20 kHz. A compression driver typically uses a voice coil and a diaphragm compressed in a chamber to pass sound waves through a small opening (throat) attached to an acoustic horn body (mouth). A tweeter, on the other hand, typically creates sound from a voice coil which is suspended within a magnetic field and attached to a diaphragm, but lacks a horn body.

As a non-limiting example, stereo systems are frequently used in boats or other aquatic environments, and speakers are often mounted on boat towers. A boat tower is typically an arch-like structure which may be mounted to a boat for use in towing an individual(s) participating in watersports, aiding in equipment storage, providing shade from the sun, and often serves as a mounting structure for various types of equipment such as audio speakers (which are often referred to as “tower speakers” when used in this manner). In this marine environment, tower speakers are often used to project music a long distance to the individual(s) participating in the watersport behind the boat and therefore must cut through a significant amount of background noise. Moreover, tower speakers must be able to withstand years of exposure to the outdoor elements including water, UV rays, salt, and others.

In conventional multi-driver speakers, a single compression driver is typically utilized for the higher frequencies because it is more affordable, and to a lesser extent, one to two tweeters are also used. However, the frequency response with the conventional compression driver is often erratic which leads to poor sound quality, and it is difficult to fit more than two tweeters within a speaker. Moreover, the conventional compression driver poses additional challenges especially when used in the non-limiting example of an aquatic environment. In conventional tower speakers, the compression driver is often mounted on the back of the woofer; but as a result of this mounting position, the compression driver must pass through the woofer which causes an entry-way for water into the tower speaker which can lead to failure. While this entryway could be sealed (e.g. with a rubber surround), such a seal lowers the efficiency of the woofer which is particularly problematic with tower speakers that need to project music longer distances. With loudspeakers, the “efficiency” refers to the sound level in decibels (dB) measured from a distance of one meter. Since decibels are a measure of volume and not power, a more efficient speaker will seem louder at a given input of power. For example, a speaker with an efficiency of 99 dB will sound louder than a speaker with an efficiency of 96 dB. Accordingly, the conventional mounting location of the compression driver to the back of the woofer, and the standard water-proofing seal, lower the efficiency of the woofer and cause the traditional multi-driver speaker to produce lower volumes.

Accordingly, there is a significant need for a multi-driver speaker which produces a more balanced frequency response and improved acoustic quality. In addition, there is also a need for multi-driver speakers in aquatic environments to be waterproof and robust enough to withstand years of outdoor use without sacrificing efficiency. Along with other features and advantages outlined herein, the speaker apparatuses within the scope of present embodiments meet these and other needs. In doing so, the speaker apparatuses, according to multiple embodiments and alternatives, have better performance, maintain a balanced frequency response, produce improved acoustic quality, and stay water-proofed without losing efficiency.

### SUMMARY OF EMBODIMENTS

According to multiple embodiments and alternatives, the speaker apparatuses (sometimes referred to herein as “speakers”, “speaker apparatus”, or “speaker” for brevity) comprise a multi-driver speaker having a woofer and an array of tweeters positioned in front of the woofer. In some embodiments, the woofer is sealed within a speaker enclosure, and at least three tweeters are mounted to the front of the woofer. The speaker enclosure is generally hollow, adapted to receive the woofer and an array of tweeters, and comprises a front and back opening. In some embodiments, the speaker enclosure is generally spherical and tapers inwards from the front opening, thus the diameter of the back opening is smaller than the diameter of the front opening. According to multiple embodiments and alternatives, the array of tweeters are positioned within the front opening of the speaker enclosure and the outside surface of the speaker enclosure may form a plurality of grooves.

According to multiple embodiments and alternatives, a cover (which is adapted to receive the tweeter array) is placed about, and securely attaches to, the front opening of the speaker enclosure. In some embodiments, a mesh screen attaches to the cover to protect the tweeter array from dust and the like. A back member is securely attached to the back opening of the speaker enclosure, and provides a waterproof seal for the speaker enclosure. In some embodiments, a swiveling clamp is rotatably connected to the top of the speaker apparatus and wires extend from the clamp for connecting to an external audio system.

Compared to conventional loudspeakers, including tower speakers, the speaker apparatuses according to multiple embodiments produce better acoustic quality and maintain a waterproof seal without losing efficiency. In doing so, the speaker apparatuses utilize multiple tweeters which maintain the output, or sound pressure level (SPL), similar to the SPL of a compression driver, but provide a more balanced frequency response than a compression driver. Accordingly, the speaker apparatuses provide a number of advantages over conventional loudspeakers and boat tower speakers, along with other features disclosed herein.

### BRIEF DESCRIPTION OF THE FIGURES

The drawings and embodiments described herein are illustrative of multiple alternative structures, aspects, and features of the present embodiments, and they are not to be understood as limiting the scope of present embodiments. It will be further understood that the drawing Figures described and provided herein are not to scale, and that the embodiments are not limited to the precise arrangements and instrumentalities shown.

FIG. 1 is a perspective view of a speaker apparatus, according to multiple embodiments and alternatives.

FIG. 2 is a rear, perspective view of a speaker apparatus, according to multiple embodiments and alternatives.

FIG. 3 is a front view of a speaker apparatus, according to multiple embodiments and alternatives.

FIG. 4 is a side view of a speaker apparatus, according to multiple embodiments and alternatives.

FIG. 5 is a perspective view of a speaker apparatus with a mesh cover, according to multiple embodiments and alternatives.

FIG. 6 is an exploded view of a speaker apparatus, according to multiple embodiments and alternatives.

FIG. 7 is a perspective view of a speaker apparatus, according to multiple embodiments and alternatives.

FIG. 8 is a rear, perspective view of a speaker apparatus, according to multiple embodiments and alternatives.

FIG. 9 is a front view of a speaker apparatus, according to multiple embodiments and alternatives.

FIG. 10 is a perspective view of a speaker apparatus with a mesh cover, according to multiple embodiments and alternatives.

FIG. 11 is an exploded view of a speaker apparatus, according to multiple embodiments and alternatives.

### MULTIPLE EMBODIMENTS AND ALTERNATIVES

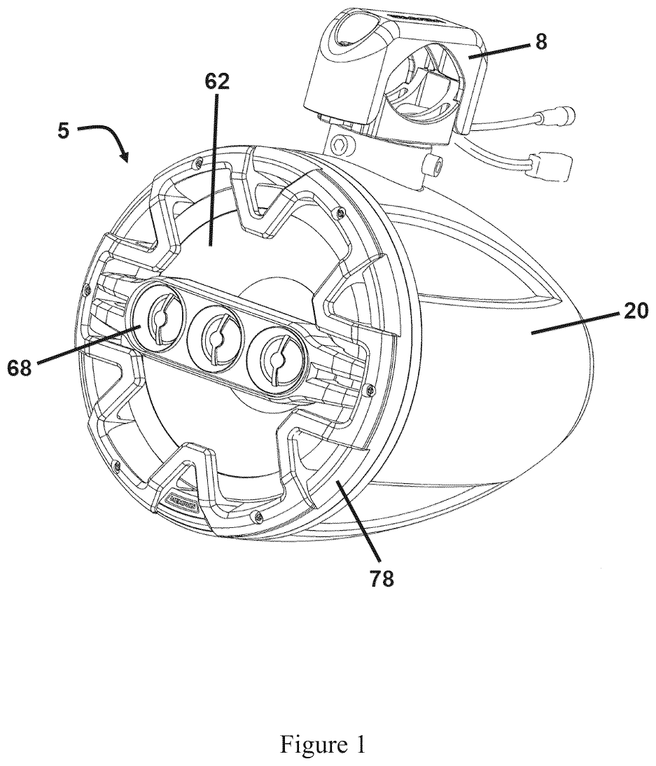

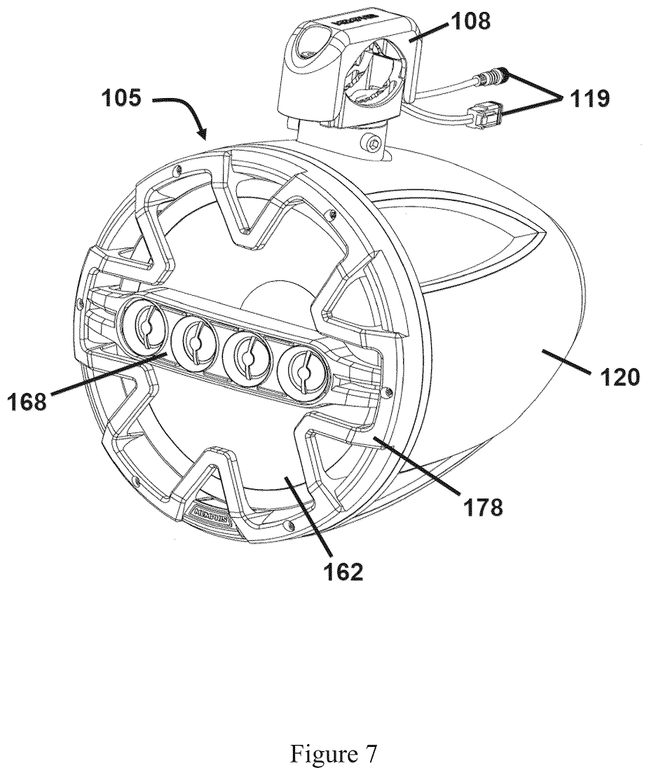

FIG. 1 illustrates speaker apparatus 5 comprising a speaker enclosure 20, a woofer 62 positioned within the speaker enclosure 20, and an array of tweeters 68 positioned in the front of the woofer 62. In some embodiments, the array comprises at least three tweeters and said array is mounted to the front of the woofer 62. As shown in FIG. 1, three tweeters are illustrated, but four or more tweeters (as shown in FIG. 7) may also be utilized. In FIG. 1, the front of the speaker enclosure 20 is adapted to receive and connect to a cover 78, which is placed about the array of tweeters 68. The woofer 62 and the array of tweeters 68 are positioned to project sound towards the front the speaker apparatus 5 (i.e. towards the cover 78 shown in FIG. 1).

As illustrated in FIGS. 1-3, and 6, an optional swiveling clamp 8 connects to the top of the speaker enclosure 20. The clamp 8 comprises a seat 10, a bottom member 15, and a top member 18. The seat 10 extends from the top of the speaker enclosure 20 and is adapted to rotatably receive a bottom member 15. In turn, the bottom member 15 is adapted to receive a top member 18. One or more cables 19 may extend from the clamp 8 for connection to an audio system (not depicted). The clamp 8 is adjustable and can connect the speaker 5 to a variety of items of different sizes. Moreover, the clamp 8 can be easily rotated to adjust the direction in which the speaker apparatus 5 projects sound.

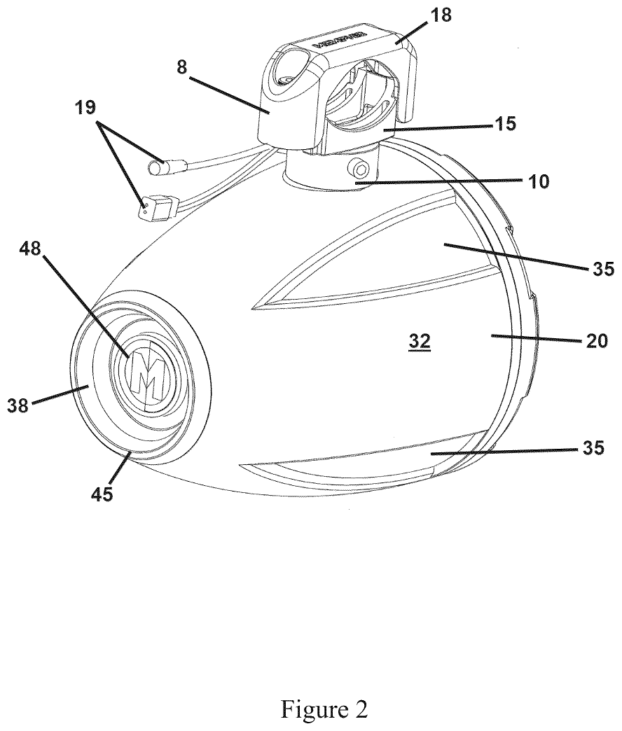

FIG. 2 illustrates the external surface 32 of speaker enclosure 20. In some embodiments, the external surface 32 defines a plurality of grooves 35 which extend for a certain length along the speaker enclosure 20. A back member assembly 38 is securely attached to a back opening 25 of speaker enclosure 20. The back member assembly 38 comprises a back member speaker enclosure 45, which forms a waterproof seal with the back opening 24. The speaker enclosure 45 is further adapted to receive a removable knob 48. In some embodiments, the back member assembly 38 lacks rubber and may utilize closed cell foam, glue, or other materials known to one of ordinary skill in the art to maintain a waterproof seal.

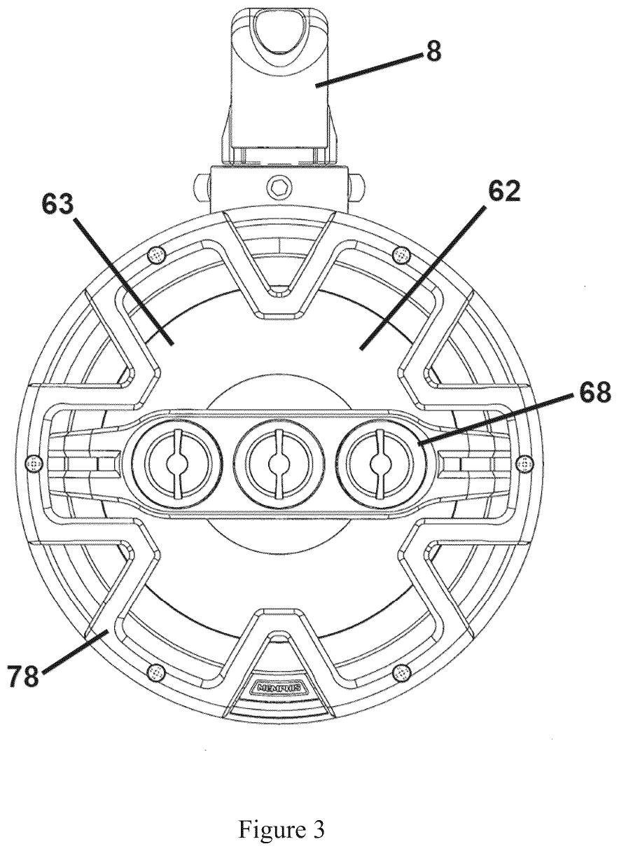

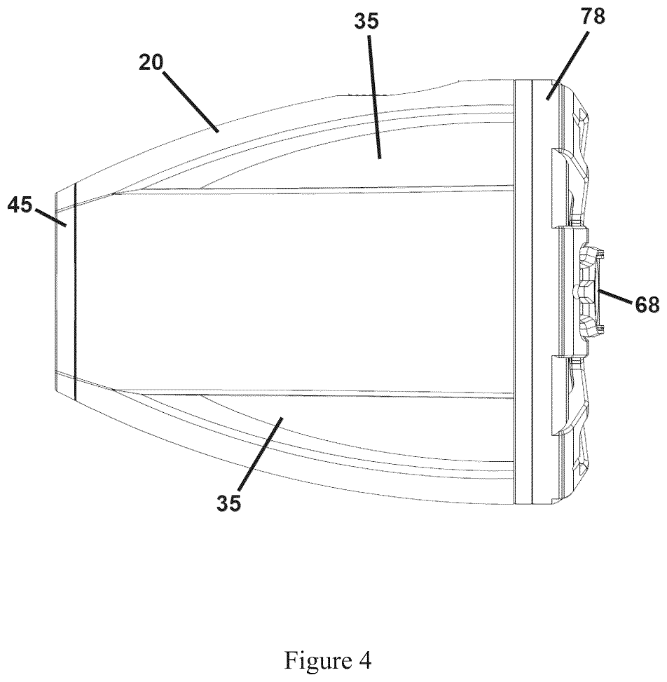

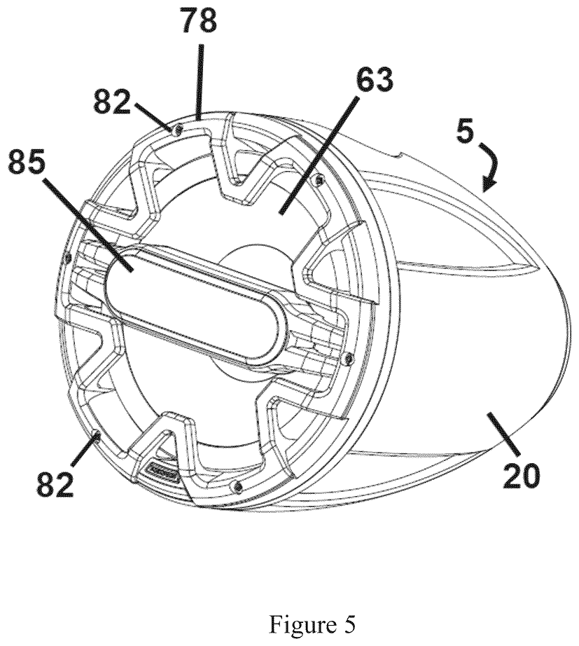

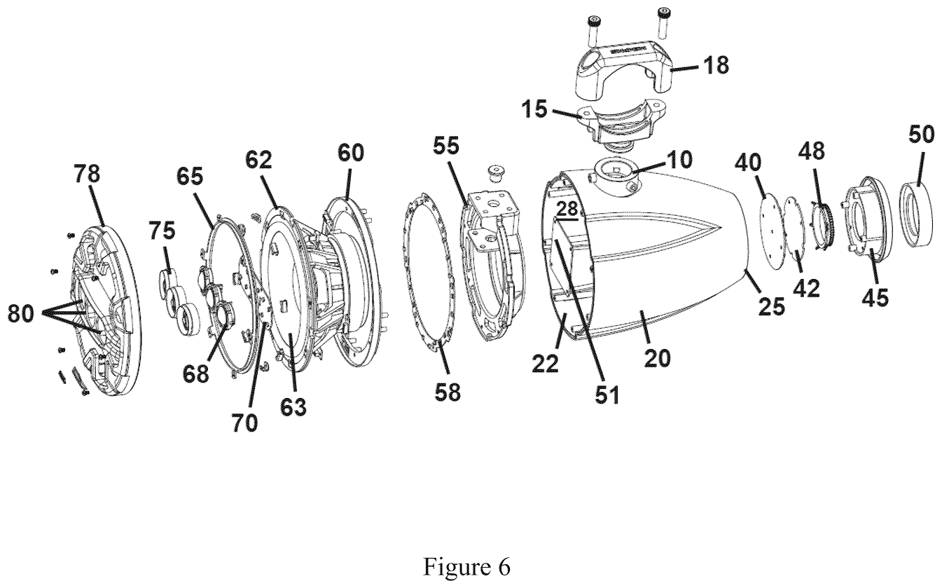

As shown in FIGS. 3-5, the woofer 62 has a cone 63 positioned proximal to the array of tweeters 68 and within the speaker enclosure 20. The array of tweeters 68 are positioned in front of the cone 63 and received within cover 78. As best illustrated in FIG. 6, the cover 78 forms a plurality of tweeter borings 80 which are adapted to receive the array of tweeters 68 and the tweeter lenses 75. Cover 78 also forms a plurality of screw borings 82, which are adapted to receive a number of screws which attach the cover 78 to the woofer assembly 52. FIG. 5 illustrates a mesh cover 85 which can be utilized to cover and protect the array of tweeters 68. In some embodiments, the mesh cover 85 securely attaches to the outside of cover 78 and is positioned directly in front of the tweeters 68.

As shown in FIG. 6, the speaker enclosure 20 defines a front opening 22 and a back opening 25 (which has a smaller diameter than the front opening 22). The seat 10 extends from the top of speaker enclosure 20 and is rotatably attached to bottom member 15. In turn, bottom member 15 is adapted to receive top member 18 and can be secured by a pair of screws. The back member assembly 38 comprises a first plate 40, a second plate 42, a back member speaker enclosure 45, a knob 48, and a seal 50. The back member assembly 38 is received within the back opening 25, and forms a waterproof seal to prevent water and other items from entering into speaker enclosure 20 during operation.

In FIG. 6, the speaker enclosure 20 tapers inward from the front opening 22 towards the back opening 25. Speaker enclosure 20 further comprises an internal surface 28, which forms a plurality of grooves and tubes that are adapted to receive the woofer assembly 52. The woofer assembly 52 comprises a plate 51, a basket 55, a first ring 58, a second ring 60, the woofer 62, and an external ring 65. The basket 55 is adapted to receive the first ring 58, the second ring 60, and the woofer 62. In turn, the second ring 60 defines a plurality of extensions which are received within the first ring 58 and the basket 55. The woofer 62 comprises the typical components known to one of ordinary skill in the art including a cone 63, a surround, a voice coil, a spider, a top plate, a magnet, a back plate, and a pole piece (which are not numbered). The front surface of the woofer 62 defines a plurality of bores which are adapted to receive a plurality of screws. The front surface of the woofer 62 is also adapted to receive the external ring 65.

FIG. 6 illustrates a plurality of tweeter lenses 75 which are adapted to receive the array of tweeters 68. In some embodiments, the array of tweeters 68 are mounted to the tweeter lenses 75 and the back plate 70 is mounted to the array of tweeters 68 to seal the tweeters 68 to the lenses 75 and the cover 78. The external ring 65 defines a plurality of tabs (not numbered) which receive the cover 78. The plurality of tabs further define a number of bores which are adapted to receive a plurality of screws to attach the cover 78 to the external ring 65. The cover 78 defines a plurality of bores 80 which are adapted to receive the array of tweeters 68 and the tweeter lenses 75. The cover 78 also defines a plurality of screw receiving bores 82 (best illustrated in FIG. 5) and cover 78 comprises a number of arms which form a non-limiting shape of a six-sided asterisk (best illustrated in FIG. 3). The woofer assembly 52 and the array of tweeters 68 are electronically connected to one another, and capable of electrical connection to an external audio source, such that the woofer assembly 52 produces the lower-pitched frequencies and the array of tweeters 68 produce the higher-pitcher frequencies.

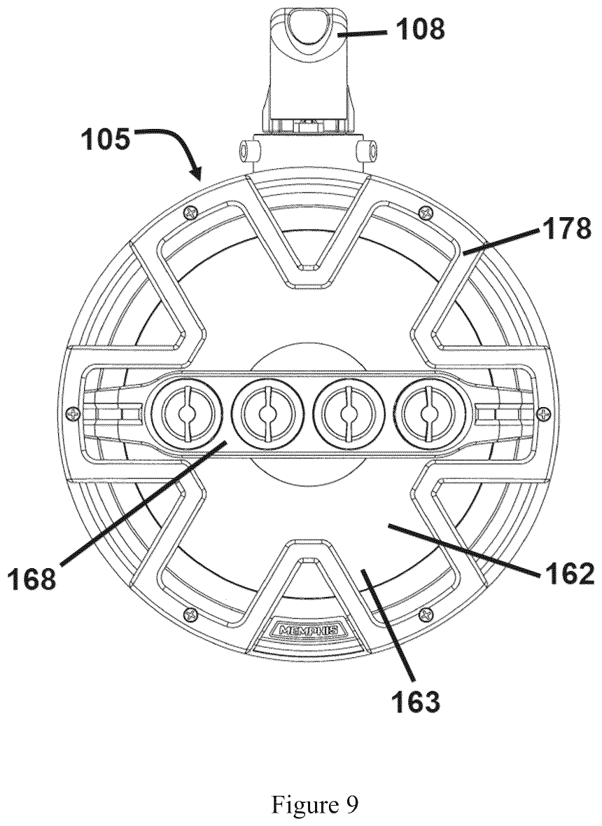

FIGS. 7-11 illustrate speaker apparatus 105 comprising a 4-tweeter array 168. According to multiple embodiments and alternatives, the speaker apparatus comprises at least four tweeters positioned in front of the woofer 162. Woofer 162 is securely positioned within speaker enclosure 120 and the array of tweeters 168 are positioned in front of the woofer 162. As shown in FIG. 7, both the woofer 162 and the array of tweeters 168 are positioned to project sound towards the cover 178. In some embodiments, a swiveling clamp 108 is adjustably connected to the top of speaker enclosure 120 and cables 119 extend from the clamp 108 for connection to an external audio system. The woofer 162 and the array of tweeters 168 are electronically connected to one another, and capable of electrical connection to an external audio source, such that the woofer assembly 152 produces the lower-pitched frequencies and the array of tweeters 168 produce the higher-pitcher frequencies.

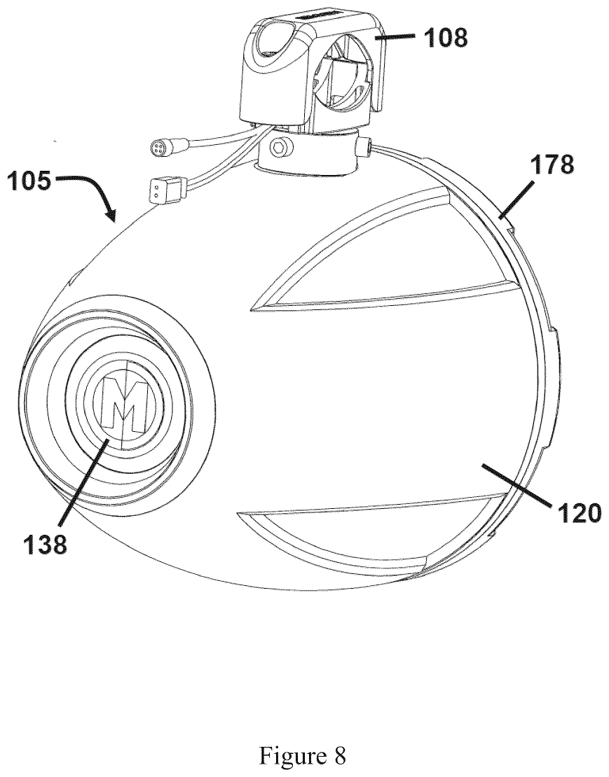

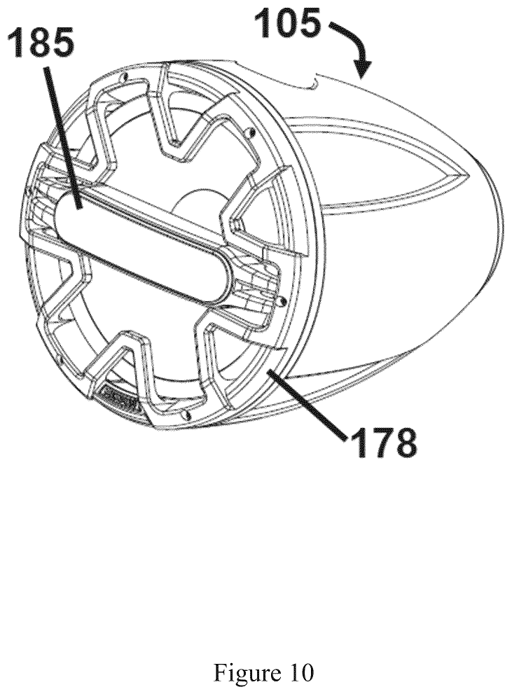

FIG. 8 illustrates the back member assembly 138 which provides a waterproof seal for the back opening 125 of speaker enclosure 120. As shown in FIG. 10, in some embodiments a mesh cover 185 is attached to the front of cover 178 and directly in front of the array of tweeters 168.

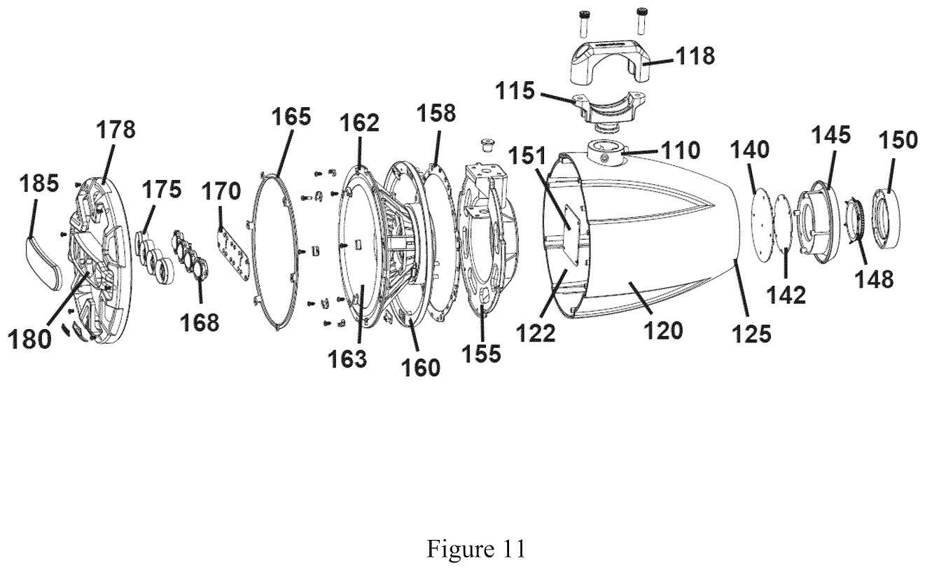

FIG. 11 illustrates an exploded view of speaker apparatus 105. Similar to speaker apparatus 5, the speaker enclosure tapers inward from the front opening 122 towards the back opening 25. A seat 110 extends from the top of speaker enclosure 120 is rotatably attached to bottom member 15, which is adapted to receive top member 118. The back member assembly 138 comprises a first plate 140, a second plate 142, a back member speaker enclosure 145, a knob 148, and a seal 150. The back member assembly 138 is received within the back opening 125, and forms a waterproof seal to prevent water and other items from entering into speaker enclosure 120 during operation.

As shown in FIG. 11, the woofer assembly 152 comprises a plate 151, a basket 155, a first ring 158, a second ring 160, the woofer 162, and an external ring 165. The basket 155 is adapted to receive the first ring 158, the second ring 160, and the woofer 162. In turn, the second ring 160 defines a plurality of extensions which are received within the first ring 58 and the basket 55. The front surface of the woofer 162 defines a plurality of bores which are adapted to receive a plurality of screws. The front surface of the woofer 162 is also adapted to receive the external ring 65.

FIG. 11 illustrates the array of tweeters 168 which are mounted to, or received within, the plurality of tweeter lenses 175. In some embodiments, the back plate 170 is then mounted to the back of the array of tweeters to seal the tweeters 168 to the lenses 175 and the cover 178. The external ring 65 defines a plurality of tabs (not numbered) which receive the cover 178. The plurality of tabs further define a number of bores which are adapted to receive a plurality of screws to attach the cover 178 to the external ring 165. The cover 78 defines a plurality of bores 180 which are adapted to receive the array of tweeters 168 and the tweeter lenses 175.

It will be understood that the embodiments described herein are not limited in their application to the details of the teachings and descriptions set forth, or as illustrated in the accompanying figures. Rather, it will be understood that the present embodiments and alternatives, as described and claimed herein, are capable of being practiced or carried out in various ways.

Also, it is to be understood that words and phrases used herein are for the purpose of description and should not be regarded as limiting. The use herein of “including,” “comprising,” “e.g.,” “containing,” or “having” and variations of those words is meant to encompass the items listed thereafter, and equivalents of those, as well as additional items.

Accordingly, the foregoing descriptions of several embodiments and alternatives are meant to illustrate, rather than to serve as limits on the scope of what has been disclosed herein. The descriptions herein are not intended to be exhaustive, nor are they meant to limit the understanding of the embodiments to the precise forms disclosed. It will be understood by those having ordinary skill in the art that modifications and variations of these embodiments are reasonably possible in light of the above teachings and descriptions.

1. A speaker apparatus, comprising:
a woofer;
an array of tweeters; and
a speaker enclosure;
wherein the woofer is positioned within the speaker enclosure and the array of tweeters are positioned in front of the woofer.

2. The speaker apparatus of claim 1, wherein the array comprises at least three tweeters.

3. The speaker apparatus of claim 2, further comprising a front cover;
wherein the speaker enclosure defines a front opening and a back opening, the front opening being adapted to receive the front cover.

4. The speaker apparatus of claim 3, wherein the front cover is adapted to receive the array of tweeters; and
the array of tweeters is positioned within the front opening of the speaker enclosure.

5. The speaker apparatus of claim 4, wherein the array of tweeters comprises a front surface and a rear surface, and the woofer comprises a front surface; and
wherein the front surface of the woofer and the front surface of the array of tweeters each face towards the front cover to emit sound waves thru the front opening of the speaker enclosure.

6. The speaker apparatus of claim 4, wherein a back member assembly lacking rubber is securely mounted to the back opening of the speaker enclosure.

7. The speaker apparatus of claim 4, wherein the speaker enclosure tapers inwardly from the front opening to the back opening, and the front opening has a diameter that is greater than a diameter of the rear opening.

8. A speaker apparatus suitable for use in an aquatic environment, comprising:
a woofer;
an array of tweeters comprising at least three tweeters; and
a speaker enclosure having a cylindrical shape, said speaker enclosure defining a front opening and a back opening;
wherein the woofer is positioned within the speaker enclosure, and the array of tweeters is positioned within the front opening of the speaker enclosure and in front of the woofer.

9. The speaker apparatus of claim 8, further comprising a front cover being adapted to receive the array of tweeters, wherein the front opening of the speaker enclosure is adapted to receive the front cover.

10. The speaker apparatus of claim 9, wherein the array of tweeters further comprise a tweeter lens being adapted to receive the at least three tweeters;
wherein the at least three tweeters define a rear surface of the array and the tweeter lens defines a front surface of the array; and
wherein the front surface of the woofer and the front surface of the array each face towards the front cover to emit sound waves thru the front opening of the speaker enclosure.

11. The speaker apparatus of claim 8, wherein a back member assembly lacking rubber is coupled to the back opening of the speaker enclosure.

12. The speaker apparatus of claim 8, wherein the speaker enclosure tapers inwardly from the front opening to the back opening.

13. A speaker apparatus suitable for use in an aquatic environment, comprising:
a woofer having a front surface;
an array of tweeters having at least three tweeters received within and mounted to a tweeter lens, wherein the tweeter lens defines a front surface of the array and the at least three tweeters define a rear surface of the array;
a speaker enclosure having a cylindrical shape, said speaker enclosure defining a front opening and a back opening, wherein the speaker enclosure tapers inwardly from the front opening to the back opening, and the front opening has a diameter that is greater than a diameter of the rear opening; and
a front cover being adapted to receive the array of tweeters, wherein the front opening of the speaker enclosure is adapted to receive the front cover;
wherein the woofer is positioned within the speaker enclosure, and the array of tweeters is positioned within both the front opening of the speaker enclosure and the front cover;
wherein the front surface of the woofer and the front surface of the array each face towards the front cover to emit sound waves thru the front opening of the speaker enclosure.

14. The speaker apparatus of claim 13, wherein a back member assembly lacking rubber is coupled to the back opening of the speaker enclosure.

15. The speaker apparatus of claim 13, wherein a mesh cover is mounted to a front surface of the front cover to protect said array of tweeters.

16. The speaker apparatus of claim 13, wherein a back plate is mounted to the rear surface of the array.

17. The speaker apparatus of claim 14, wherein the back member assembly forms a waterproof seal with the back opening of the speaker enclosure.

18. The speaker apparatus of claim 13, wherein the woofer is electronically connected to the array of tweeters; and
wherein the woofer and the array of tweeters are capable of electronic connection to an external audio source.

19. The speaker apparatus of claim 6, wherein the back member assembly forms a waterproof seal with the back opening of the speaker enclosure.

20. The speaker apparatus of claim 11, wherein the back member assembly forms a waterproof seal with the back opening of the speaker enclosure.
